(19) United States
(12) Patent Application Publication
(10) Pub. No.: US 2022/0230375 A1
(43) Pub. Date: Jul. 21, 2022

(54) THREE-DIMENSIONAL AVATAR GENERATION AND CUSTOMIZATION

(71) Applicant: Krikey, Inc., Menlo Park, CA (US)

(72) Inventors: Ketaki Lalitha Uthra Shriram, San Francisco, CA (US); Jhanvi Samyukta Lakshmi Shriram, San Francisco, CA (US); Jae Hyun Seong, La Habra, CA (US); Jonathan Lerner, Reseda, CA (US)

(21) Appl. No.: 17/579,485

(22) Filed: Jan. 19, 2022

Related U.S. Application Data
(60) Provisional application No. 63/139,033, filed on Jan. 19, 2021.

(51) Int. Cl. G06T 13/40; G06T 19/00; G06T 19/20

(52) U.S. Cl. CPC G06T 13/40; G06T 19/20; G06T 19/006

(57) ABSTRACT

An augmented reality (AR) application enables customization and manipulation of three dimensional (3D) avatars on a mobile client. The application provides a variety of options for modifying the physical appearance of an avatar, including base features such as skin tone and body shape. When a user adjusts these base features, application may make corresponding adjustments to part features (e.g., clothing items) that are displayed over the base features. The application provides the customized avatars for display, including in performances of animations (e.g., dances). The application enables interactive cameras such as smooth panning and zooming for a user to see their customized avatar from various angles. The application renders depth of the 3D using shaders optimized for use on a mobile client. The shaders may reuse framebuffers on an as-needed basis. The application renders shading that accounts for both virtual and physical light sources.

### CROSS REFERENCE TO RELATED APPLICATIONS

This application claims the benefit of U.S. Provisional Application No. 63/139,033, filed Jan. 19, 2021, which is incorporated by reference in its entirety.

This application also relates to U.S. patent application Ser. No. ______, filed Jan. 19, 2022, titled “Three-Dimensional Avatar Generation and Manipulation Using Shaders”, which is incorporated by reference in its entirety.

### TECHNICAL FIELD

The disclosure generally relates to the field of mobile rendered augmented reality and more specifically to customizing avatars using shaders in mobile rendered augmented reality environments.

### BACKGROUND

Conventional graphics rendering systems dedicate a shader per rendered object. allows for high fidelity, realistic rendering, but also increases the memory costs for rendering graphics on a mobile device. Furthermore, conventional augmented reality (AR) systems executed on mobile devices aim to create interactions between AR objects and real-world environments. However, while most shaders in fully virtual worlds are optimized to interact with a singular light source, in AR, there are multiple light sources in both the virtual world and the physical world. Conventional shaders do not adapt to both of these light sources and fail to create AR objects that appear realistic in augmented reality environments. Additionally, conventional AR systems limit users to viewing AR objects from a fixed camera view, which limits user interactions with AR objects and prohibits attaining a realistic experience with the objects.

### SUMMARY

An AR system allows users to create and engage with customized avatars. An avatar customization application of the AR system provides various options for customizing the physical appearance of an avatar. A user can customize base features, like skin tone and body height, and part features, like clothes and accessories. The avatar customization application provides coloring and shading on a continuous scale, providing the user with customization flexibility. The avatar customization application provides various camera views for viewing the customized avatar at various angles. For example, the application can smoothly rotate a camera view of an avatar according to a user's swipe across a touchscreen displaying the avatar. The avatar customization application can also insert the user's customized avatar into an existing video clip (e.g., a cutscene of a videogame) to further personalize the user's experience. Furthermore, the avatar customization application accounts for both virtual and physical light sources when rendering shading of an AR object. In these ways, the AR system described herein provides increased customization and immersion with an AR environment over conventional AR systems.

To optimize functionality for AR applications on a mobile device, the AR system described herein reduces the memory and network bandwidth resources expended by the mobile device. To render shading of an AR object (e.g., a 3D avatar), the avatar customization application can reuse shaders and corresponding framebuffers storing shading values. For example, rather than dedicating a framebuffers to store shading values of each clothing item for customizing an avatar, the avatar customization application uses framebuffers for clothing items that are displayed to the user and releases framebuffers when the clothing items are no longer displayed. In this way, the avatar customization application uses shaders and memory resources on an as-needed basis. Additionally, by avoiding download of dedicated shaders, the avatar customization application also reduces network bandwidth that would otherwise be needed to communicate data for each dedicated shader's framebuffer. In yet another way that the AR system reduces memory and the network bandwidth usage required, the avatar customization application may provide a portion of options for customization to be downloaded at the mobile device. For example, rather than provide the entirety of available part features for download, the avatar customization application provides a subset that the user has selected or that is available depending on the location of the mobile client. In at least these ways, the AR system described herein optimizes avatar customization and manipulation for mobile client devices.

In one example embodiment, an avatar customization application receives, from a mobile device, a modification to a base feature of a three dimensional (3D) avatar generated using base features (e.g., body shape) and part features (e.g., clothing). The part features are displayed over at least one of the base features. The appearance of the base features can be unaffected by changes to the part features. The appearance of at least one of the part features can be affected by changes to the base features. The avatar customization application identifies a part feature displayed over the modified base feature and determines a modification to the part feature based on the modification to the base feature. The avatar customization application provides for display through the mobile client device an animation depicting a first view of the 3D avatar. The first view can include the modified base feature and the modified part feature at a first angle. The avatar customization application receives, during display of the animation and from the mobile client device, a request to display a second view of the 3D avatar. The second view can include the modified base feature and the modified part feature at a second angle. The avatar customization application determines the second angle from which to display the modified base and part features in the animation and provides for display through the mobile client device the animation depicting the second view of the 3D avatar.

For example, a user controlling the 3D avatar initiates a dance animation performed by the 3D avatar, and while the avatar is following the dance animation, the user swipes their finger across the touchscreen display on which the animation is displayed to request to view the dance animation from a different angle. The avatar customization application can provide a smooth panning of the dance animation from the initial angle to the requested angle, showing the user's customized avatar from a substantially continuous range of angles upon the user's request.

The base features can include physical features of a human body. For example, the base features of an avatar representing a human figure include a head, hair style, shoulder width, waist circumference, arm length, height, weight, skin tone, etc. The avatar customization application can determine a proportionate change in a size of the part feature in response to the modification to the base feature including a change in a size of the base feature. For example, the avatar customization application can modify the width of a dress upon a user changing the waist circumference of their avatar. The avatar customization application can provide for display through a mobile client device a slider for selecting an appearance parameter from a continuous scale of parameters for the base feature. In one example, the continuous scale of parameters corresponds to a representation of a weight of a body of the avatar. In another example, the continuous scale of parameters represents a skin tone.

The 3D avatar can be an augmented reality (AR) avatar. The avatar customization application can modify user permissions to enable a user to request a change in a presently displayed view of the AR avatar in response to determining that the AR avatar is provided for display on a flat, real-world surface (i.e., a real-world surface located digitally in a 3D coordinate plane onto which the AR avatar is also located). For example, if the AR avatar is in a free fall from a higher elevation to a lower elevation, the avatar customization application may prevent the user from being able to rotate the view of the AR avatar. When the AR avatar has landed on a flat surface, the avatar customization application may resume allowing the user to rotate the view of the AR avatar. The avatar customization application can provide the animations with one or more of a continuous panning camera view or a zooming camera view. The request to display different views of the 3D avatar can be detected at the mobile client device upon user interaction with the continuous panning camera view (e.g., swiping their finger on a touchscreen display to rotate the avatar) or the zooming camera view (e.g., pinching or expanding two fingers to zoom out and in, respectively, on a touchscreen display).

The avatar customization application can customize video clips to include the user's customized 3D avatar. The avatar customization application can receive a template for a video clip. This template can initially include a 3D avatar that the avatar customization application can replace with the user's customized 3D avatar, where the user's avatar includes the modified base and part features. The avatar customization application provides for display through a mobile client device the video clip that features the 3D avatar instead of the default avatar. To promote efficient memory resource usage, the avatar customization application may provide part features for download as needed (e.g., upon user request). The part features provided to a mobile client device for download may be a portion of an entirety of available part features. The part features available to a user can depend upon a location of a mobile client device and/or time. The avatar customization application can determine a location of the mobile client device (e.g., New York City) and determine available part features depending on this location (e.g., an “I heart NY” t-shirt).

In yet another example embodiment, the avatar customization application creates a 3D avatar using a subset of a set of part features available for display over base features of the 3D avatar. The avatar customization application provides for display through a mobile client device a view of the 3D avatar. The view can include a depiction of the first part feature of the subset of part features. The avatar customization application can use a framebuffer to render shading of the first part feature. Upon determining that the depiction of the first part feature is absent from display, the avatar customization application can release the framebuffer to render shading of a different part feature.

The avatar customization application may use the framebuffer to render shading the second part feature in response to determining that a depiction of the second part feature is displayed. The avatar customization application can determine that the depiction of the second part feature is displayed upon receiving user interaction with the mobile client device to add the second part feature to the part features used to customize the avatar. The user interaction can be received during a creation process for a user to customize the 3D avatar. The avatar customization application can assign part identifiers to the part features, determine that the depiction of the first part feature is absent from the display by determining that the identifier associated with first part feature has been removed from the list of presently displayed part feature identifiers, and determine that the second part feature is present by determining that an identifier associated with the second part feature has been added to the list.

The avatar customization application can determine the shading by using virtual light sources, real-world light sources, or a combination thereof. The avatar customization application can render a 3D coordinate plane to place the 3D avatar and light sources. The avatar customization application can determine light origin coordinates for a first and second light source to be placed within the 3D coordinate plane, where light in an AR application (e.g., an AR videogame) is rendered as originating from those light origin coordinates. The avatar customization application can determine the shading of part features based on the light source origin coordinates (e.g., by determining light intensities in the coordinates of the 3D coordinate plane based on the locations of the light origin coordinates). The avatar customization application can determine a shading value for part features, or portions of the part features, on a continuous scale using the light source origin coordinates (e.g., the determined light intensities may be on a continuous scale that can map to corresponding continuous shades of a color). The avatar customization application can determine special effects using the continuous scale of shading values. The 3D avatar may be an AR avatar.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an augmented reality (AR) system environment, in accordance with at least one embodiment

FIG. 2 is a block diagram of the avatar customization application of FIG. 1, in accordance with one embodiment.

FIG. 3 is a flowchart illustrating a process for displaying a customized avatar in various views during an animation, in accordance with one embodiment.

FIG. 4 is a flowchart illustrating a process for optimizing memory resources for rendering shading of a customized avatar, in accordance with one embodiment.

FIG. 5 illustrates an avatar creation interface, in accordance with one embodiment.

FIG. 6 illustrates the use of a framebuffer in an avatar creation interface, in accordance with one embodiment.

FIG. 7 illustrates an insertion of a customized avatar into a video, in accordance with one embodiment.

FIG. 8 illustrates shading of a customized avatar of an AR application, in accordance with one embodiment.

FIG. 9 illustrates a block diagram including components of a machine able to read instructions from a machine-readable medium and execute them in a processor (or controller), in accordance with at least one embodiment.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Augmented Reality System Environment

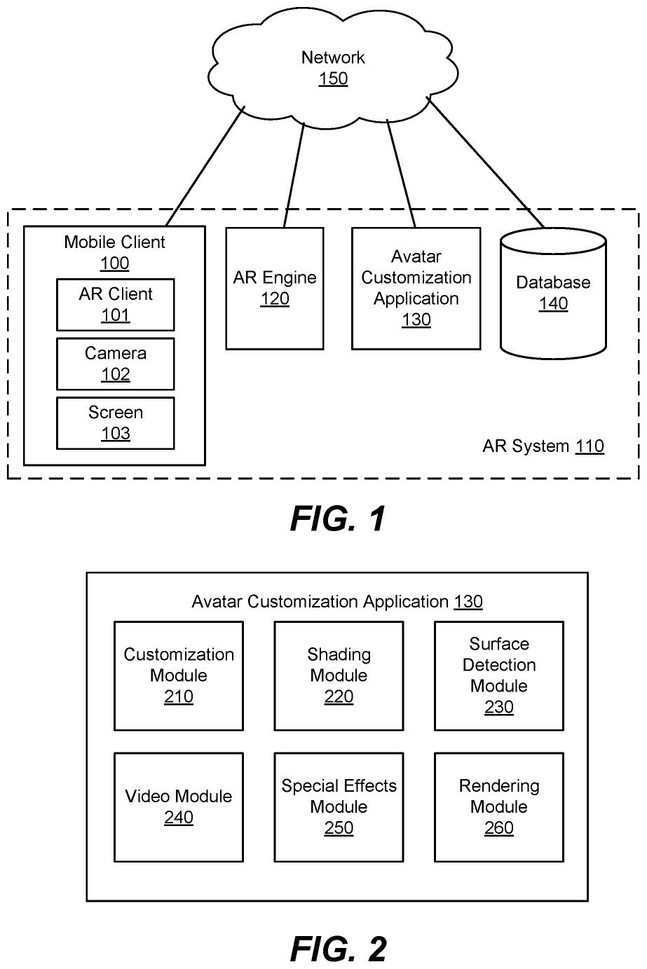

FIG. 1 illustrates an augmented reality (AR) system environment, in accordance with at least one embodiment. The AR system environment enables AR applications on a mobile client 100, and in some embodiments, presents customized and dynamic experiences to users via avatar creation and optimized shading. The customized avatars described herein may be any suitable virtual avatar (e.g., virtual reality (VR), AR, 2D, 3D, etc.), and the term “avatar” is used throughout the application to refer to any suitable virtual avatar. The system environment includes a mobile client 100, an AR system 110, an AR engine 120, an avatar customization application 130, a database 140, and a network 150. The AR system 110, in some example embodiments, may include the mobile client 100, the AR engine 120, the avatar customization application 130, and the database 140. In other example embodiments, the AR system 110 may include the AR engine 120, the avatar customization application 130, and the database 140, but not the mobile client 100, such that the AR system 110 communicatively couples (e.g., wireless communication) to the mobile client 100 from a remote server.

The mobile client 100 is a mobile device that is or incorporates a computer. The mobile client may be, for example, a relatively small computing device in which network, processing (e.g., processor and/or controller) and power resources (e.g., battery) may be limited and have a formfactor size such as a smartphone, tablet, wearable device (e.g., smartwatch), virtual reality headset, and/or a portable internet enabled device. The limitations of such device extend from scientific principles that must be adhered to in designing such products for portability and use away from constant power draw sources.

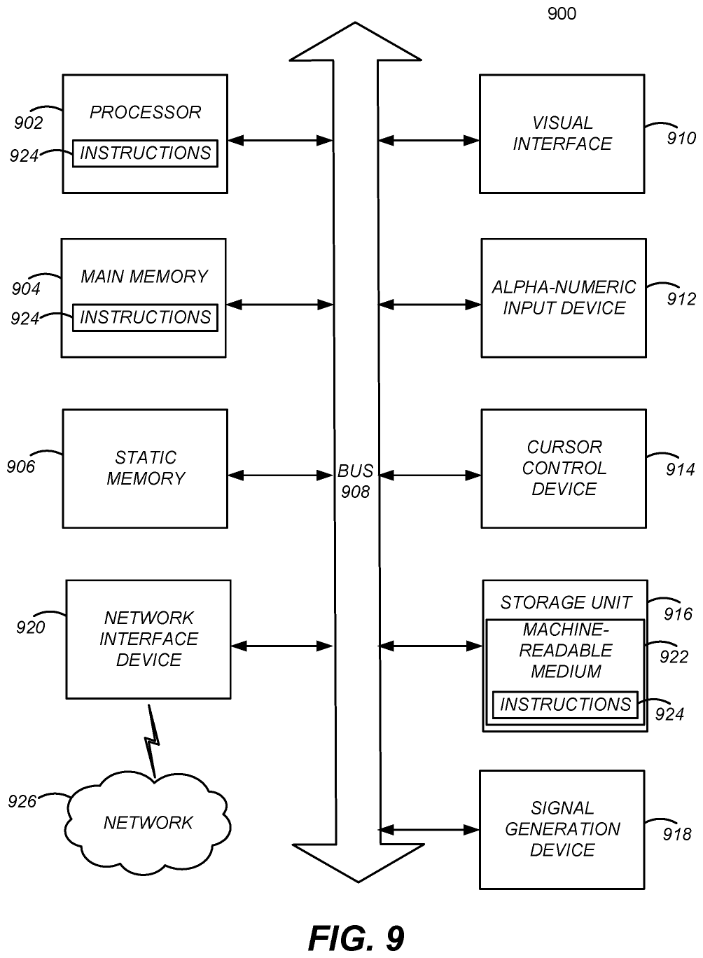

The mobile client 100 may be a computing device that includes some or all of the components of the machine depicted in FIG. 9. For example, the mobile client 100 has one or more processors (generally, processor) and a memory. It also may include a storage, networking components (either wired or wireless). The processor is configured as a special purpose processor when executing the processes described herein. The mobile client 100 can communicate over one or more communication connections (e.g., a wired connection such as ethernet or a wireless communication via cellular signal (e.g., LTE, 5G), Wi-Fi, satellite) and includes a global positioning system (GPS) used to determine a location of the mobile client 100.

The mobile client 100 also includes one or more cameras 102 that can capture forward and rear facing images and/or videos. The mobile client 100 also includes a screen (or display) 103 and a display driver to provide for display interfaces on the screen 103 associated with the mobile client 100. The mobile client 100 executes an operating system, such as GOOGLE ANDROID OS and/or APPLE iOS, and includes the screen 103 and/or a user interface that the user can interact with. In some embodiments, the mobile client 100 couples to the AR system 110, which enables it to execute an AR application (e.g., the AR client 101).

The AR engine 120 interacts with the mobile client 100 to execute the AR client 101 (e.g., an AR game). For example, the AR engine 120 may be a game engine such as UNITY and/or UNREAL ENGINE. The AR engine 120 displays, and the user interacts with, the AR game via the mobile client 100. For example, the mobile client 100 may host and execute the AR client 101 that in turn accesses the AR engine 120 to enable the user to interact with the AR game. Although the AR application refers to an AR gaming application in many instances described herein, these are merely exemplary. The principles described herein for the AR application may apply in other context, for example, a retail application integrating AR for modeling purchasable products, an educational application integrating AR for demonstrating concepts within a learning curriculum, or any suitable interactive application in which AR may be used to augment the interactions. In some embodiments, the AR engine 120 is integrated into and/or hosted on the mobile client 100. In other embodiments, the AR engine 120 is hosted external to the mobile client 100 and communicatively couples to the mobile client 100 over the network 150. The AR system 110 may comprise program code that executes functions as described herein.

In some example embodiments, the AR system 110 includes the avatar customization application 130. The avatar customization application 130 enables customized avatar generation, animation, and cutscenes. For example, the user can select physical features to correspond with their avatar's body (e.g., weight, height, skin tone, hair color, eye color, scars, birthmarks, etc.) for display in the AR game (e.g., during gameplay or cutscenes). In some embodiments, the user can select from a continuous scale of colors or numbers to change the avatar's physical appearance. For example, the user selects form a continuous scale of number values corresponding to the width of the avatar's hips. This is one example in which the avatar customization application 130 can provide a continuous scale of parameters that represent a weight of the avatar's body. The avatar customization application 130 enables optimized shading for reduced memory consumption, reduced processing resource consumption, and dynamic generation of special effects.

The avatar customization application 130 may generate an avatar, which may be a digital representation of a user's character in a virtual (e.g., AR or VR) environment. The avatar customization application 130 may generate the avatar by accessing a rig, which can be an outline or skeleton of the avatar's anatomy (e.g., a human anatomy, feline anatomy, anatomy of a mythical creature, etc.). The rig can include a main body and various extensions (e.g., limbs or appendages) attached to the main body via nodes (e.g., joints). The avatar customization application 130 may access predetermined movement configurations of the rig (e.g., walking, jumping, sitting, waving, dancing, etc.).

In generating the avatar, the avatar customization application 130 may overlay meshes on top of the rig. A mesh is a layer of the avatar defining a shape of the avatar in greater detail than defined by the rig. For example, meshes can define the body weight, height, or proportions of the avatar. The avatar customization application 130 may apply a default rig and a default set of meshes. The avatar customization application 130 can accept user-specified modifications to the rig and meshes to change the physical features of the avatar's body. Base features of avatars may refer to parameters of meshes and rigs that define these physical features. Such parameters can include a height, widths (e.g., a shoulder, bust, or hip width), a skin tone (or complexion), or any suitable parameter describing physical features of the avatar. The avatar customization application 130 can additionally accept user-specified additions and removals of clothing, accessories, equipment, wearable effect (e.g., a halo of light around the avatar), or any other suitable wearable object by the avatar. Wearable objects may be generated on the avatar via additional mesh layers over the base features. Part features of avatars may refer to wearable objects and/or parameters describing the physical appearance of the wearable objects (e.g., color of the object). Rigs, predetermined movement configurations of the rigs, and meshes may be stored in the database 140.

Additionally, the avatar customization application 130 may overlay shading on top of the avatar's meshes to render depth or special effects. For example, the avatar customization application 130 overlays a series of shading layers over time on top of a part feature's mesh layer to generate the effect of a dress moving in the wind under the sun. The avatar customization application 130 may account for one or more light sources, including virtual and real world light sources, when determining shading. Colors of part and base features may have corresponding shades. The avatar customization application 130 may represent each shade by a quantitative value (e.g., a number having floating point precision). The values for the shades of each color may be stored in framebuffers for generating the shading layers as angles between the avatar and light sources change. The avatar customization application 130 may have access to a set of framebuffers of a mobile client device, e.g., the device 100, that may have limited local memory. The avatar customization application 130 can optimize shading by reusing framebuffers between one or more part features instead of dedicating a framebuffer to shading each part feature. To reuse framebuffers, the avatar customization application 130 uses a framebuffer for a part feature that is displayed to the user (e.g., for a shirt presently worn by the avatar) and releases the frame buffer when the part feature is swapped for another (e.g., the user removes the shirt in favor of a sweater).

The database 140 stores data for rendering a customized avatar and operation of the customized avatar. The database 140 can store avatars created by users or default avatars that can be modified to create customized avatars. The database 140 may store base features and part features that can be used to create the customized avatars. Identifiers for the base and part features may also be stored in the database 140. In some embodiments, the database 140 stores the shading values for rendering shading of base and part features of an avatar. The database 140 can store animations that can be performed by the avatar. The database 140 may include templates for video clips (e.g., cutscenes) that can be modified by the avatar customization application 130 to insert a user's customized avatar. The database 140 may store user profiles of the users of the avatar customization application 130 (e.g., name, location, preferences, or any suitable biographical information).

The network 150 transmits data between the mobile client 100 and the AR system 110. The network 150 may be a local area and/or wide area network that uses wired and/or wireless communication systems, such as the internet. In some embodiments, the network 150 includes encryption capabilities to ensure the security of data, such as secure sockets layer (SSL), transport layer security (TLS), virtual private networks (VPNs), internet protocol security (IPsec), etc.

### Example Avatar Customization Application

FIG. 2 is a block diagram of the avatar customization application 130 of FIG. 1, in accordance with one example embodiment. The avatar customization application 130 includes a customization module 210, a shading module 220, a surface detection module 230, a video module 240, a special effects module 250, and a rendering module 260. In some embodiments, the avatar customization application 130 includes modules other than those shown in FIG. 2. The modules may be embodied as program code (e.g., software comprised of instructions stored on non-transitory computer readable storage medium and executable by at least one processor such as the processor 902 in FIG. 9) and/or hardware (e.g., application specific integrated circuit (ASIC) chips or field programmable gate arrays (FPGA) with firmware. The modules correspond to at least having the functionality described when executed/operated.

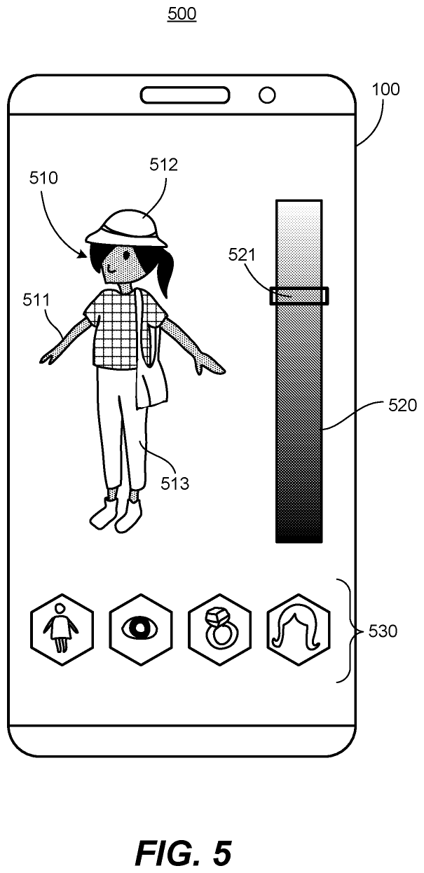

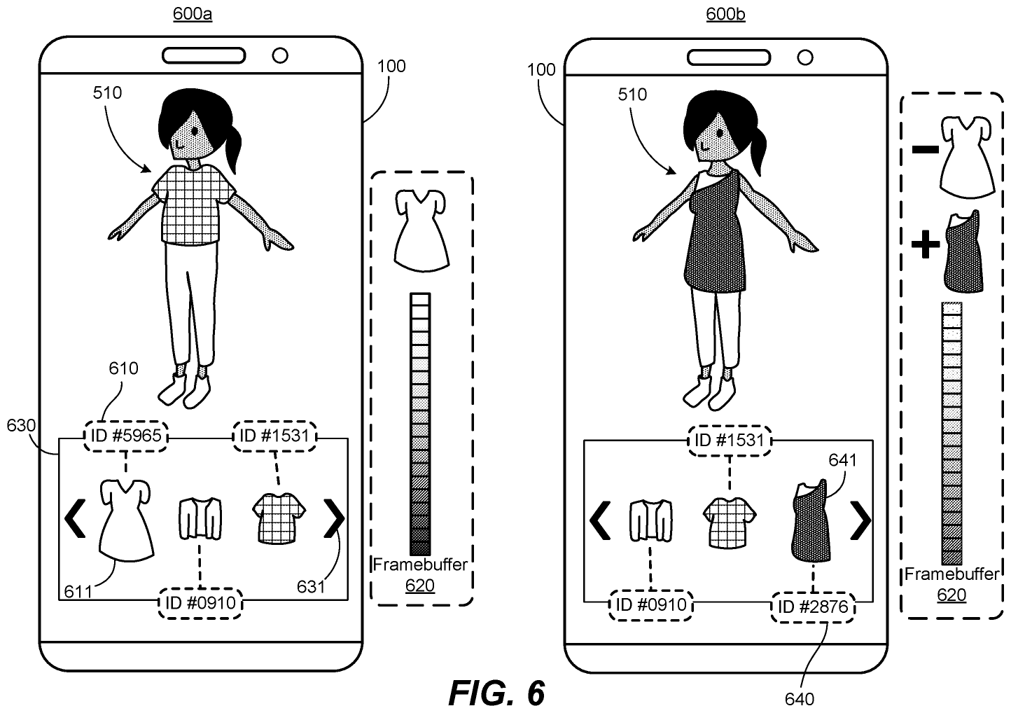

The process of engaging with a customized avatar may begin with the creation of the customized avatar. The avatar customization application 130 generates an interface for display through the mobile client 100 that includes interface elements for selecting and modifying base and part features (e.g., as shown in FIGS. 5 and 6). Generating or providing for display through a mobile client device may include displaying on the device (e.g., at the screen of the device) or displaying using the device (e.g., the mobile client device coupled to a projector or suitable display external to the device, where the projector or suitable display external to the device displays the customized avatar). To provide this interface depicting the avatar and options for base and part features, the avatar customization application 130 renders shading of the base and part features using a variety of shades available from a continuous scale of values that can be stored in a framebuffer and selected by the user. As the user adds, swaps, and removes part features, the avatar customization application 130 may optimize the use of these framebuffers by reusing framebuffers across part features rather than dedicate framebuffers for each part feature. The avatar customization application 130 determines shading values based on virtual light sources, real-world light sources, or both. The avatar customization application 130 may allow the user to view their avatar from various angles using a smooth panning camera and/or zooming camera. The avatar customization application 130 can animate the customized avatars and allow the user to view them from various, continuous angles. The avatar customization application 130 can also insert the customized avatar into a video clip, such as a cutscene, to further personalize the user's experience with the AR client 101.

The customization module 210 creates an avatar that can be customized by a user. The customization module 210 can receive modifications to base features and part features that are used to generate the avatar. For example, during an avatar creation process of the AR client 101, a user can change base features such as the height or other body measurements of their avatar. These changes may be the modifications received by the customization module 210 from the user's mobile client 100 that is running the AR client 101. The customization module 210 may identify a part feature displayed over the base feature that was modified and determine an appropriate modification to the display of the part feature. For example, if the user has increased the height of the avatar, the customization module 210 may identify one or more part features that are affected by the change (e.g., the clothes and shoes) and modify the size of the part features (e.g., proportionally relative to the affected part feature and potentially related features) to accommodate for the increased height of the avatar. Each part feature may have an identifier, and the customization module 210 may maintain a list of part feature identifiers that are displayed over certain base features. In response to determining that a parameter of the base feature has been modified (e.g., the user selects a wider shoulder width for their avatar), the customization module 210 may identify the part feature identifier displayed over the modified base feature and determine a proportional modification (e.g., increasing the width of an article of clothing at the shoulders by the same increase in width that the user selected). Thus, the customization module 210 may determine a modification to a part feature using the modification to the base feature.

The customization module 210 may reduce the memory resources utilized by the avatar customization application 130 by maintaining copies of part features at local memory of mobile client devices on an as-needed basis. While the entirety of part features that have been created for use by the AR client 101 to customize an avatar may be vast, a user may not need to access this wide selection to operate the AR client 101. The customization module 210 may provide a portion of the entirety of part features available to a user for download by the mobile client device upon user request. For example, the customization module 210 provides the part features that a user has selected for their avatar's wardrobe for local storage at the mobile client 100. The customization module 210 can continue to provide additional part features as the user selects others or cause downloaded part features to be deleted from local storage of the mobile client 100 as the user leaves them unused for a threshold period of time (e.g., a week) to further conserve storage space at the mobile client 100.

The customization module 210 can provide part features depending on a location of the mobile client 100. In some embodiments, the customization module 210 determines a location of the mobile client 100 and uses the location to determine part features that are available for the user to decorate their avatar. The customization module 210 can determine a location of a mobile client device by using global positioning system (GPS) capabilities of the device, an internet protocol (IP) address used by the mobile client device, or a user-provided location. In one example, the customization module 210 determines, using IP addresses of users' mobile client devices, to exclusively provide, for example, a kurti to decorate an avatar for devices identified as located in India, a hanbok to decorate avatars for devices identified as located in Korean and exclusively provide a sarafan to decorate avatars for devices identified as located in Russia.

The customization module 210 may assign avatar ensemble identifiers to a combination of base and/or part features that a user has selected for their avatar. The customization module 210 may periodically assign ensemble identifiers (e.g., to new combinations of base and part features) or assign ensemble identifiers in response to a user requesting an avatar's appearance be saved. The customization module 210 may map combinations of base and/or part features to ensemble identifiers and store them as data structures in the database 140. Each data structure may also include a flag that the customization module 210 may set as the actively used ensemble of the user's avatar. This flag may be used to identify, by the video module 240, a customized avatar's present ensemble for use in personalizing a video clip (e.g., a cutscene).

In some embodiments, the customization module 210 accesses data related to the user's physiology (e.g., weight, height, heart rate, running speed, etc.) or user's physical appearance (e.g., weight, height, hair color, hair style) to generate a realistic rendering of the user as their avatar. The customization module 210 may access data from software applications on the mobile client device 100 (e.g., a health application or a social media application). Alternatively or additionally, this data may be stored in the database 140 for access by the customization module 210.

The shading module 220 renders shading of the avatar. The shading module 220 can render shading of base features or part features. The shading module 220 can generate shading as an additional mesh layer over layers used for base and part features. This layer can be referred to as a “shader.” The shading module 220 uses framebuffers to render shades of colors. Framebuffers can store these shades. Each base feature or part feature may have its own framebuffer dedicated to storing its shades of colors. However, this may require a high amount of memory resources, especially to support a large and diverse amount of customizable base and part features. To reduce the usage of memory resources, which is especially valuable for mobile client devices with limited memory resources, the shading module 220 may reuse framebuffers for two or more features (e.g., part features).

In some embodiments, the shading module 220 determines whether a part feature is presently displayed through the mobile client 100. The shading module 220 may use a part feature identifier, as assigned by the customization module 210, to determine whether the part feature is presently displayed. For example, the rendering module 260 may maintain a list of presently displayed part feature identifiers. The term “presently displayed” may refer to the current display of an AR object through a mobile client device (e.g., at the screen of the mobile client device or at a projector coupled to the mobile client device) and optionally, that is not occluded by a real-world object. Likewise, the term “presently absent from display” or “absent from display” may refer to the current lack of display of the AR object or the occlusion of the object by a real-world object. The shading module 220 may use framebuffers for each part feature having an identifier in the list of presently displayed part feature identifiers. In response to determining that a part feature is removed from this list, the shading module 220 may release the corresponding framebuffer used to render shading for that part feature. Thus, freeing up the framebuffer for use to render shading of a different part feature. The shading module 220 may, once a framebuffer is available, download shading values of a part feature that is determined to be presently displayed from the database 140 into the available framebuffer.

The shading module 220 may determine which shade value of various shade values stored in a framebuffer to apply to a part feature (e.g., to apply to one triangle of the triangle mesh that forms the part feature). The shading module 220 may use multiple light sources affecting an avatar to determine the shade value. These light sources can include both real world and virtual light. The rendering module 260 may render the avatar on a 3D coordinate plane, and the shading module 220 may determine locations of light origin coordinates corresponding to where light from either a real world or virtual light source originates. The shading module 220 may receive light intensity as measured by a sensor of the mobile client 100 (e.g., the camera 102). The shading module 220 may access a combination of light intensity data mapped to orientation data of the mobile client 100 (e.g., as captured by inertial measurement units of the mobile client 100) to determine the orientation of the camera 102 relative to real world light sources in an environment.

Additionally, or alternatively, the shading module 220 may access image data captured by the camera 102 to identify sources of light depicted in images or videos captured by the camera 102. In one example, the shading module 220 may apply a machine learning model to identify light sources depicted in images, where the machine learning model is trained on historical images labeled with the presence of light sources. Thus, the shading module 220 may detect an orientation of the camera 102 relative to real world light sources using computer vision. In one example of an orientation of the camera 102 relative to the real world light source, the orientation includes angles of elevation or depression from the camera 102 to the light source. The orientation may also include distances from the camera 102 to the light source as measured using the camera 102 and various images of the real world environment. Using the orientation, the shading module 220 may determine a light origin coordinate of a real world light source in the 3D coordinate plane. Virtual objects, as rendered by the rendering module 260, may also serve as a light source (e.g., a fire, sparkles, lamps of a game). As the rendering module 260 determines where in the 3D coordinate plane that the light-emitting virtual objects are to be rendered, the shading module 220 accesses the corresponding light origin coordinates of virtual objects from the rendering module 260.

Using the light origin coordinates of the light sources to which the avatar is exposed, the shading module 220 determines the shading of a part feature. The shading module 220 may determine various shades for a single part feature. For example, for a part feature rendered using a triangular mesh layer, the shading module 220 determines a shade of color for each triangle. The shading module 220 may determine a light intensity at various coordinates of the 3D coordinate plane depending on the distance from the coordinates to a light origin coordinate in the 3D coordinate plane. The shading module 220 may determine is the light at a light origin coordinate is directional (e.g., a spotlight) or omnidirectional (e.g., an overhead lightbulb, a fire). The shading module 220 may determine if surfaces, virtual or real-world, are reflective. The shading module 220 may include light origin coordinates corresponding to reflective surfaces. The color value chosen from the framebuffer used for the part feature can depend on the determined light intensity values and/or the presence of an occluding object. For example, the shading module 220 may determine that the back of an avatar facing a light is occluded by the front of the avatar, and the shading module 220 may assign the darkest shade to the color the back of the avatar. In another example, the shading module 220 determines, for each triangle mesh of a triangular mesh layer used to render a part feature, the shading of each triangle mesh depending on the determined light intensity values. The shading value in a framebuffer may be values on a substantially continuous scale. In one example of substantially continuous, the shading values may be on a scale from −1 to 1 using contiguous values that are 0.01 (i.e., 0.5% of the range) apart from one another.

The surface detection module 230 may determine that the avatar is located on a flat surface. The surface detection module 230 analyzes images captured by the camera 102 to determine surfaces within the images. The surface detection module 230 may cluster feature points of the images, where the feature points may be determined using the AR engine 120, to identify distinct features in the images such as objects and surfaces. Examples of surface distinction for an AR client is further described in U.S. patent application Ser. No. 17/170,431, entitled “Surface Distinction for Mobile Rendered Augmented Reality” and filed Feb. 8, 2021, which is incorporated by reference in its entirety. The surface detection module 230 may perform functions similar to the surface distinction application described in U.S. patent application Ser. No. 17/170,431.

The video module 240 creates a video clip featuring a customized avatar. The video module 240 may receive a template for a video clip from the database 140 or a third-party video provider. Examples of video clips include cutscenes in video games, where gameplay is paused to provide the video clip to the user. While video game cutscenes can be fixed such that all players view the same cutscene, the video module 240 may generate personalized cutscenes. The template received by the video module 240 can include a modifiable field that, by default, is populated with an identifier for a default avatar. The video module 240 may replace the identifier for the default avatar with an identifier for a user's latest avatar (e.g., avatar ensemble identifier as assigned by the customization module 210 and flagged as actively being used for the user's current avatar). The user's latest avatar may include base features and part features that the user has modified from the default avatar's appearance. The video module 240 can then provide the video clip to the mobile client 100, where the video clip has a modified template to include the user's avatar.

The special effects module 250 generates special effects using the continuous shading scale maintained by the shading module 220. The special effects module 250, rather than rely on preconfigured graphic textures for rendering each special effect, executes computer instructions to produce the same special effects using the continuous shading scale. In some embodiments, the special effects module 250 generates special effects based on a type of effect. Types of effects include fire, water, bubbles, sparks, or any suitable category of visual effect generated to simulate a natural or supernatural phenomena. For example, the special effects module 250 can generate special effects for a boiling cauldron, where the types of special effects include the flames beneath the cauldron and the bubbles emerging from the cauldron. The special effects module 250 can generate the bubbles using a continuous shading scale of blue and can generate the flames using a continuous shading scale of red. While the color may be selected to maximize a realistic appearance of special effects, the special effects module 250 can use any color and a continuous shading scale of that color to generate any special effect. Furthermore, one type of special effect may be colored using continuous shading scales of multiple colors (e.g., bubbles that change from blue to green as the user tosses objects into the cauldron). By having the flexibility to use a continuous shading scale of any color to generate a special effect without a predetermined set of colors established for each effect, which can also be referred to as a “baked in texture,” the special effects module reduces the memory resources expended by the customization module 210. By contrast, a baked in texture, which can take the form of an image file, can occupy a large amount of memory for each special effect that is to be generated.

The rendering module 260 provides for display, on the mobile client 100, a customized avatar. In one example, the customization module 210 and shading module 220 creates the avatar's custom appearance, using user-selected base and part features, for the AR engine 120 to generate. The rendering module 260 determines a 3D coordinate plane onto which to place the created avatar, where the rendering module 260 has also mapped the locations of real (or physical) world surfaces and light sources onto the 3D coordinate plane. The rendering module 260 may maintain a list of presently displayed virtual objects, where each object is identified by an identifier. For example, each part feature used to decorate a custom avatar may be identified by part feature identifiers, and a list of presently displayed part feature identifiers is maintained by the rendering module 260.

The rendering module 260 may receive user interactions with the mobile client 100 to interact with the AR client 101. User interactions may depend on the client device and its input interfaces. For example, a device with a touchscreen may receive user interactions such as swipes of finger or movement between two fingers to request changes in camera views of an avatar displayed on the touchscreen. In another example, a device with a keyboard input interface may receive user selections of arrow keys to control the camera views for displaying different angles of the avatar. The rendering module 260 can enable continuous panning or zooming of the display. This can be compared to a display with fixed angles of view. For example, some first person shooting video games allow a player to toggle between fixed angles of camera views, such as a view from the avatar's perspective and a view from behind the avatar. In contrast, the rendering module 260 enables a user to select from a substantially continuous range of angles (e.g., every 1 degree or 0.1 degrees of rotation about the avatar).

The rendering module 260 may provide animations for display through the mobile client device. The animations may be predetermined movement configurations of a rig of an avatar (e.g., walking, jumping, sitting, waving, dancing, etc.) that are accessible to the rendering module 260 from storage in the database 140. The rendering module 260 can provide an animation at various angles for the user to view using a continuous panning camera view or a zooming camera view.

The rendering module 260 may determine a different angle from which to display customized avatar (e.g., while the avatar is performing an animation). The rendering module 260 may use a combination of an initial angle that the avatar is being displayed (e.g., in a first view) and a user's request to see the avatar in a second view (e.g., a second angle). For example, the rendering module 260 receives, from the mobile client 100, a speed and distance of a user's swipe across the screen 103 (e.g., a touchscreen displaying the animation). The rendering module 260 then determines a change in angle corresponding to the speed and distance of the user's swipe. For example, the user swipes in a direction on the screen corresponding to a negative ninety degrees alpha angle (i.e., of Euler angles) rotation, a zero degree rotation in the beta angle, and a zero degree rotation in the gamma angle. The rendering module 260 then calculates the new second angle using the first angle of the first view that was previously presented to the user (e.g., adding the angle rotation amount to the first angle to calculate the second angle).

The rendering module 260 may provide user input elements to provide for display, e.g., on a screen of device. The user input elements enable the user to customize an avatar. User input elements may include buttons, sliders, menus, wheels (e.g., color wheels), or any other suitable interface element for selecting from a substantially continuous scale of parameters (e.g., colors, sizes, numbers, etc.) characterizing the physical features of an avatar. The rendering module 260 may also modify user permissions to enable a user to request a change in a presently displayed view of an avatar. In some embodiments, the rendering module 260 determines whether the avatar is on a flat surface. If the avatar is on a flat surface, the rendering module 260 fulfills user requests to change the camera view of the avatar. If the avatar is not on a flat surface, the rendering module 260 may deny the user's request and maintain the current view of the avatar. The rendering module 260 may provide views of the avatar (e.g., during an animation of the avatar) using a continuous panning camera view, zooming camera view, or combination thereof.

### Processes for Rendering Customized Avatars

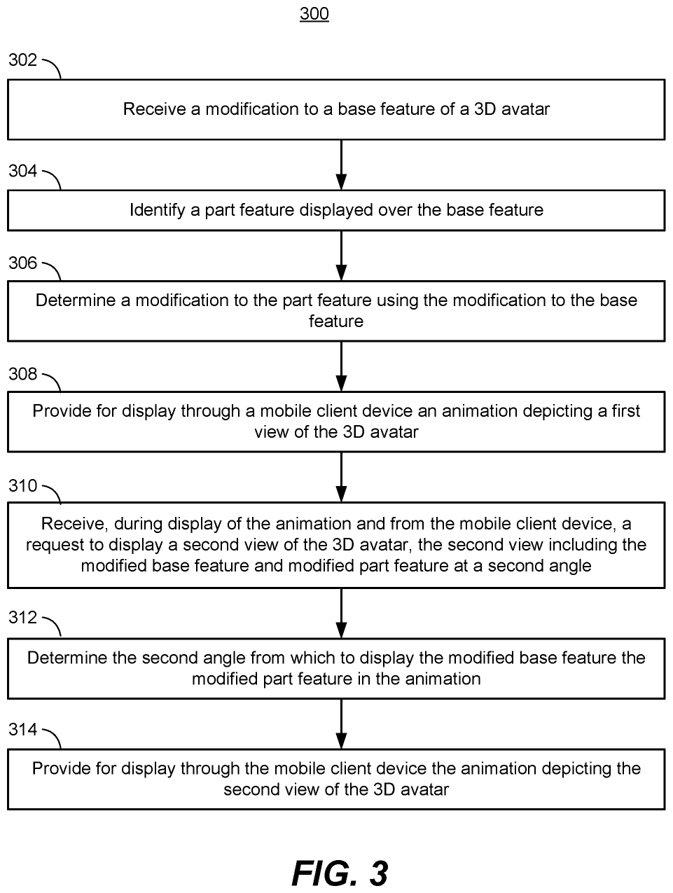

FIG. 3 is a flowchart illustrating an example process 300 for displaying (or providing for display) a customized avatar in various views during an animation, in accordance with one embodiment. The process 300 may be performed by the avatar customization application 130. The avatar customization application 130 may perform operations of the process 300 in parallel or in different orders, or may perform different, additional, or fewer steps.

The avatar customization application 130 receives 302 a modification to a base feature of a 3D avatar generated using base features and part features. The avatar may be generated for display through a mobile client device. The part features may be displayed over at least one of the base features. The base features may be unaffected by changes to the part features. At least one of the part features can be affected by changes to the base features. For example, a change in the avatar's clothing will not necessarily change the body shape of the avatar. However, a change in the avatar's body shape should cause a change in the appearance of the avatar's clothing to maintain a realistic rendering of the customized avatar. The modification can be received during an avatar creation process. Example user interfaces that can be generated by the avatar customization application 130 for customizing the avatar are shown in FIGS. 5 and 6. The modification can be a change in a physical appearance of the avatar (e.g., body shape, body part shape, hair style, hair color, skin tone, eye color, etc.).

The avatar customization application 130 identifies 304 a part feature displayed over the base feature. The avatar customization application 130 can render part features as additional mesh layers over the mesh layers of base features. When rendering the part features over base features, the avatar customization application 130 may map or creation associations between the part features and base features. For example, part feature identifiers can be associated with the base features over which they are displayed. The avatar customization application 130 may determine the part feature identifier displayed over the base feature that has been modified. For example, the avatar customization application 130 may identify that the base feature defining the avatar's upper body has been modified to increase the width of the avatar's shoulders. The avatar customization application 130 may determine that a part feature identifier associated with a t-shirt is associated with the base feature defining the shoulder's width. The avatar customization application 130 may then identify the part feature associated with the t-shirt.

The avatar customization application 130 determines 306 a modification to the part feature using the modification to the base feature. The modification to the part feature may be proportional to the modification of the base feature. For example, the avatar customization application 130 may modify a width of a part feature (e.g., a t-shirt) by the same width of the modification to the base feature (e.g., a width of the avatar's shoulders). A user of the AR client 101 may use the user interface elements (e.g., “+” and “−” interface buttons) or expand or contract two fingers across a touchscreen to request that the base feature be modified, and the avatar customization application 130 may determine a corresponding width by which the shoulder and t-shirt should be modified.

The avatar customization application 130 provides 308 for display through a mobile client device an animation depicting a first view of the 3D avatar, the first view including the modified base feature and the modified feature at a first angle. The animation may be a predefined movement of the avatar's rig. In one embodiment, the predefined movement is not necessarily under the user's control with the exception of requesting the avatar move according to the animation. One example of an animation can be a dance move. In some embodiments, the user can control a smooth panning camera view of the avatar, using user interface elements or a touchscreen to control the rotational view (e.g., seeing the avatar from different pitch, roll, and yaw positions of the avatar). The rotational view can be specified by a set of angles (e.g., Euler angles or pitch-roll-yaw angles). The first view can be a first set of angles. For example, a first set of angles initiated to zeroes maps to a direct, front view of the avatar performing the animation.

The avatar customization application 130 receives 310, during display of the animation and from the mobile client device, a request to display a second view of the 3D avatar. The second view can include the modified base feature and modified part feature at a second angle. The request to display the second view can include a user interaction with the interface presenting the 3D avatar for display. For example, the user can use a keyboard's arrow keys or swipe their fingers on a touchscreen to request a different angle to view the animation. In some embodiments, the avatar customization application 130 may additionally or alternatively receive a request to display a different view of the 3D avatar when an animation is not displayed (e.g., while controlling the avatar to walk around a virtual environment or while customizing the avatar during an avatar creation process). In some embodiments, after the user has requested to view the avatar from a different angle, the avatar customization application 130 may maintain this modified viewing angle for subsequent operation of the AR client 101 or until the user stops using the AR client 101.

The avatar customization application 130 determines 312 the second angle from which to display the modified base feature and the modified part feature in the animation. The avatar customization application 130 may use a combination of the first view and the user's request to determine the second angle. For example, the avatar customization application 130 receives, from the mobile client 100, a speed and distance of a user's swipe across the screen 103 (e.g., a touchscreen displaying the animation). The avatar customization application 130 then determines a change in angle corresponding to the speed and distance of the user's swipe. For example, the user swipes in a direction on the screen corresponding to a negative ninety degrees alpha angle (i.e., of the Euler angles) rotation, a zero-degree rotation in the beta angle, and a zero degree rotation in the gamma angle. The avatar customization application 130 then calculates the new second angle using the first angle of the first view that was previously presented to the user (e.g., adding the angle rotation amount to the first angle to calculate the second angle).

The avatar customization application 130 provides 314 for display through the mobile client device the animation depicting the second view of the 3D avatar. The avatar customization application 130 may provide a smooth panning of the animation from the first view to the second view in substantially real time as the user requests the second view. For example, the avatar customization application 130 provides panning views of a dancing animation from substantially continuous angles (e.g., in increments of fractions of angles) between the first angle and the second angle.

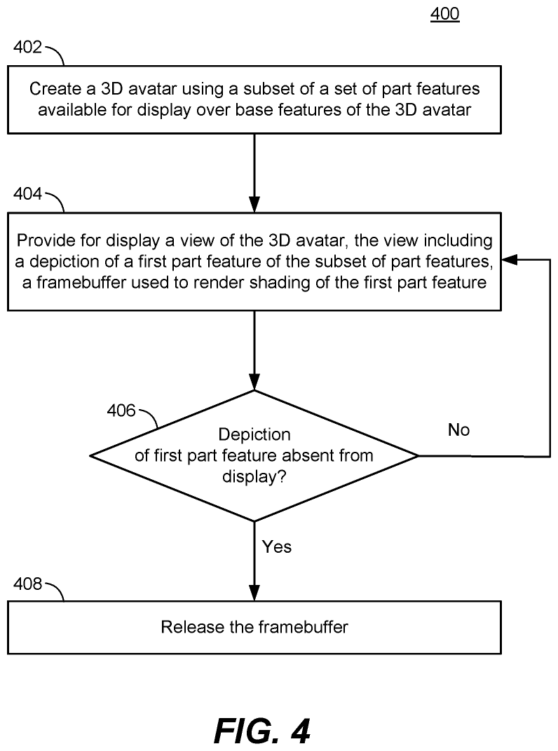

FIG. 4 is a flowchart illustrating an example process 400 for optimizing memory resources for rendering shading of a customized avatar, in accordance with one embodiment. The process 400 may be performed by the avatar customization application 130. The avatar customization application 130 may perform operations of the process 400 in parallel or in different orders, or may perform different, additional, or fewer steps.

The avatar customization application 130 creates 402 a 3D avatar using a subset of a set of part features available for display over base features of the 3D avatar. The avatar customization application 130 may provide an avatar creation interface (e.g., as shown in FIGS. 5 and 6) for receiving user selections of base features sand part features to customize their avatar. The avatar customization application 130 can create the 3D avatar by assembling the rig and mesh layers for the base and part features. The avatar customization application 130 may use the AR engine 120 to render the created avatar. The avatar customization application 130 may assign identifiers to each part feature. The avatar customization application 130 can maintain a list of presently displayed part features (e.g., on the avatar, in a virtual closet, etc.) according to the identifiers.

The avatar customization application 130 provides 404 for display, through a mobile client device, a view of the 3D avatar. The view can include a depiction of a first part feature of the subset of part features. The avatar customization application 130 can use a framebuffer to render shading of the first part feature. To render the shading of part features, the avatar customization application 130 may use a framebuffer (e.g., at the local memory of the mobile client 100) to store shading values.

The avatar customization application 130 determines 406 whether the depiction of the first part feature is absent from what is to be provided for display. If the first part feature is still present for what is to be provided for display, the process 400 may return to continue providing 404 for display the 3D avatar and allowing the user to engage with the avatar. The avatar customization application 130 releases 408 the framebuffer in response to determining that the depiction of the first part feature is absent from the display. The released framebuffer can then be accessible for use to render shading of another part feature. The avatar customization application 130 may determine 406 that the depiction of the first part feature is absent from the display by determining that the first part feature's identifier is absent from the list of presently displayed part features. The avatar customization application 130 can remove the identifier from the list upon determining that a real-world object is occluding the entirety of the first part feature, that the user has selected not to equip the avatar with the part feature, that the part feature is not displayed in a menu of part features, or a combination thereof. The avatar customization application 130 can release the framebuffer used for storing shades for the first part feature by modifying write permissions, enabling another part feature's shades to be stored in the framebuffer. An example of this process is depicted in FIG. 6 and further described below.

### Example AR Application With Customized Avatars

FIGS. 5-8 illustrate various interfaces involving a customized avatar, in accordance with various embodiments. Each interface may be an interface of the AR client 101 and displayed on the mobile client 100. The interfaces may be generated by the avatar customization application 130 for display at the mobile client 100. Although FIGS. 5-8 illustrate interface generated for display on a screen of the mobile client 100, the avatar customization application may also provide the interfaces for display through the mobile client 100 at an external display (e.g., a projector or virtual reality headset) that is communicatively coupled to the mobile client 100. For convenience, the figures are rendered as appearing two dimensional (2D) such as the avatar 510, selection tools (e.g., sliders and buttons), wearable objects to decorate the avatar 510, and AR objects such as a virtual sprite 840. Further, for convenience, the figures are rendered with limited shading (e.g., the skin tone 511 is shown as a single shade although slight variations in shades of the skin tone can be used to represent depth and shape of the body of the avatar 510). However, contents of the FIGS. 5-8 may be rendered in 3D and include shading to represent the depth of the 3D renderings.

FIG. 5 illustrates an example avatar creation interface 500, in accordance with one embodiment. The interface 500 includes an avatar 510, a slider 520, and interface selection buttons 530 for selecting part features to customize the avatar 510. The user can interact with the buttons 530 to navigate a menu of part features such as accessories (e.g., the accessory 512) and clothes (e.g., the pants 513). The user can interact with the slider 520 to select a skin tone base feature 511 having the shade 521 from the slider 520. The slider 520 has a continuous scale of skin tones from which to customize the avatar 510. The avatar customization application 130 may also provide a panning camera view so that the user may interact with the interface 500 to smoothly pan around the avatar 510 to view the avatar 510 from different angles. The avatar customization application 130 may also provide a zooming camera view so that the user may also zoom in and out to see less or more details of the avatar 510. In some embodiments, the avatar customization application 130 does not limit the user to fixed camera angles for viewing the avatar 510 from only those fixed camera angles. That is, a user may select from one of a continuous range of angles to view the avatar 510 as opposed to one of a small number of different angles (e.g., two angles).

FIG. 6 illustrates an example of the use of a framebuffer 620 in an avatar creation interface, in accordance with one embodiment. A first view 600a of the avatar creation interface and a second view 600b of the avatar creation interface are shown in FIG. 6. The second view 600b may be obtained after the user interacts with the first view 600a. The avatar creation interface includes the avatar 510 and a part feature menu 630 with a navigation button 631. The menu 630, as shown in the view 600a, includes various part features such as a dress 611 that has a part feature identifier 610. The use of dashes in FIG. 6 represents content that is not necessarily displayed at the mobile client 100 to the user, but is content used by the avatar customization application 130 in customizing the avatar 510. As shown in FIG. 6, each part feature may have a corresponding part feature identifier.

The avatar customization application 130 may generate the view 600a where the user can select from part features in the menu 630 for decorating their avatar 510. When rendering the part features for display in the avatar creation interface, the avatar customization application 130 may use framebuffers, such as the frame buffer 620, to store values for shades of colors of the part features. The framebuffer 620 (illustrated to the side in the figures for ease of discussion) includes various shades of a color that may be applied to the part feature 611. A grayscale is used for convenience of depiction in FIG. 6, but the avatar customization application 130 may use additional colors and shades thereof. The user may select the navigation button 631 to view additional part features, such as the part feature 641 having the part feature identifier 640. After the user selects the part feature 641 to decorate the avatar 510, the avatar customization application 130 generates the view 600b with the part feature 641 equipped on the avatar 510. In the view 600b, the part feature 611 is not presently displayed while the part feature 641 is presently displayed (e.g., both in the menu 630 and equipped on the avatar 510). The avatar customization application 130 releases the framebuffer 620 upon detecting that the part feature 611 is presently not displayed (e.g., after the user selects the button 631 that causes the part feature 611 to be moved left and off-screen). The avatar customization application 130 can then use the framebuffer 620 to store shade values for rendering shades of a color of the part feature 641 (e.g., via the dotted gradient pattern corresponding to the dotted pattern of the dress).

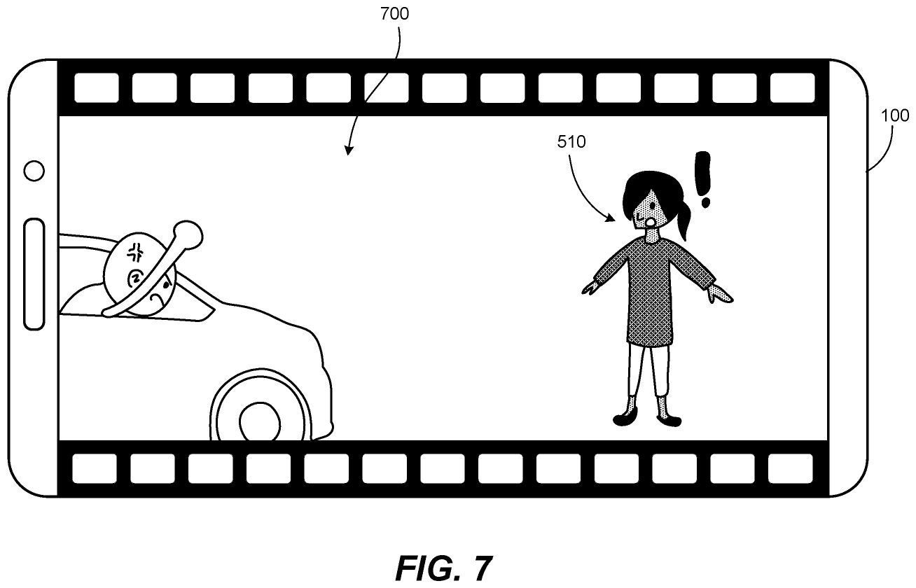

FIG. 7 illustrates an insertion of a customized avatar 510 into a video 700, in accordance with one example embodiment. The avatar customization application 130 may edit a template of the video 700 to replace a default avatar with the customized avatar 510. In some embodiments, the avatar customization application 130 pauses typical operation of the AR client 101 to cause playback of the video 700. For example, if the AR client 101 is an AR gaming application, the avatar customization application 130 may pause gameplay to display the video 700 (e.g., a cutscene) showing the user's customized avatar 510 instead of a default avatar.

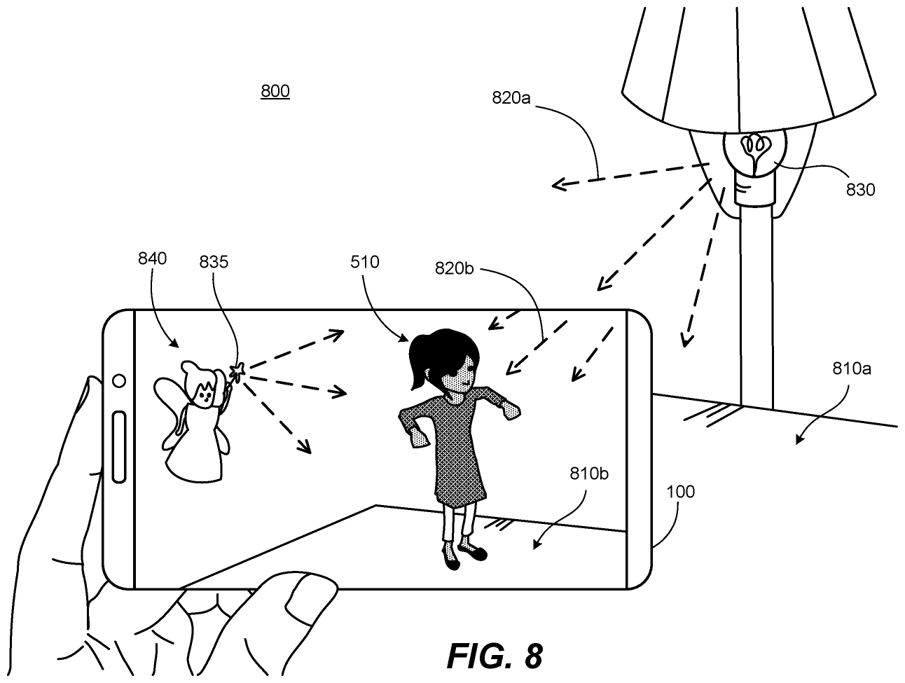

FIG. 8 illustrates shading of a customized avatar 510 of an AR application, in accordance with one example embodiment. The mobile client 100 may use the camera 102 to capture a real-world environment including a real-world surface 810 (e.g., a table) and a real-world light source 830 (e.g., a lamp) and the light 820a emitted by the light source 830. The avatar customization application 130 may combine the images or video captured by the camera 102 to render AR objects, such as the avatar 510 and the sprite 840 having a virtual light source 835, appearing within a digitally displayed version of the real-world environment. The digitally displayed version of the real-world environment includes the surface 810b corresponding to the real-world surface 810a and the light 820b corresponding to the real-world light 820a. The avatar customization application 130 renders the avatar 510 in a 3D coordinate plane with the surface 810b and light sources 830 and 835 such that the avatar 510 appears to be standing on the surface 810b and affected by the two light sources.

The avatar customization application 130 may create the 3D coordinate plane onto which to locate the AR objects 840 and 510, the surface 810b, and the light sources 830 and 835. The avatar customization application 130 can determine light origin coordinates for the light sources 830 and 835. Based on the light origin coordinates in the 3D coordinate plane, the avatar customization application 130 can also determine light intensity values at various coordinate in the 3D coordinate plane. The avatar customization application 130 can then determine, for example, how to shade the hair, skin, and clothing of the avatar 510 depending on the light intensities at the coordinates that the avatar 510 occupies (e.g., triangles of the triangular mesh that the avatar 510 is rendered with may be located at respective coordinates). In some embodiments, the avatar customization application 130 determines if there is a virtual or real-world object in the path between the light origin coordinates and a triangle mesh of the avatar 510. If there is an object occluding the path of light, the avatar customization application 130 may determine to apply the darkest shade stored in a framebuffer for the triangle mesh.

In some embodiments, the avatar customization application 130 may cause the avatar 510 to perform an animation (e.g., a dance). The avatar customization application 130 may determine that the avatar 510 is located on the flat surface of the surface 810b. The avatar customization application 130 may then enable the user to request to animate the avatar 510 and rotate a smooth panning camera view around the avatar or zoom in and out smoothly to view the animation at various angles.

### Computing Machine Architecture

FIG. 9 is a block diagram illustrating components of an example machine able to read instructions from a machine-readable medium and execute them in a processor (or controller). Specifically, FIG. 9 shows a diagrammatic representation of a machine in the example form of a computer system 900 within which program code (e.g., software) for causing the machine to perform any one or more of the methodologies discussed herein may be executed. The program code may correspond to functional configuration of the modules and/or processes described with FIGS. 1-8. The program code may be comprised of instructions 924 executable by one or more processors 902. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a portable computing device or machine (e.g., smartphone, tablet, wearable device (e.g., smartwatch)) capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes a processor 902 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 904, and a static memory 906, which are configured to communicate with each other via a bus 908. The computer system 900 may further include visual display interface 910. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 910 may include or may interface with a touch enabled screen. The computer system 900 may also include alphanumeric input device 912 (e.g., a keyboard or touch screen keyboard), a cursor control device 914 (e.g., a mouse, a trackball, a joystick, a motion sensor, or other pointing instrument), a storage unit 916, a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. The instructions 924 (e.g., software) may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 (e.g., software) may be transmitted or received over a network 926 via the network interface device 920.

While machine-readable medium 922 is shown in an example embodiment to be a single medium, the term “machine-readable medium” should be taken to include a single medium or multiple media (e.g., a centralized or distributed database, or associated caches and servers) able to store instructions (e.g., instructions 924). The term “machine-readable medium” shall also be taken to include any medium that is capable of storing instructions (e.g., instructions 924) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

To optimize functionality for AR applications on a mobile device, the AR system described herein reduces the memory and network bandwidth resources expended by the mobile device. To render shading of an AR object (e.g., a 3D avatar), the avatar customization application can reuse shaders and corresponding framebuffers storing shading values. For example, rather than dedicating a framebuffers to store shading values of each clothing item for customizing an avatar, the avatar customization application uses framebuffers for clothing items that are displayed to the user and releases framebuffers when the clothing items are no longer displayed. In this way, the avatar customization application uses shaders and memory resources on an as-needed basis. Additionally, by avoiding download of dedicated shaders, the avatar customization application also reduces network bandwidth that would otherwise be needed to communicate data for each dedicated shader's framebuffer. In yet another way that the AR system reduces memory and the network bandwidth usage required, the avatar customization application may provide a portion of options for customization to be downloaded at the mobile device. For example, rather than provide the entirety of available part features for download, the avatar customization application provides a subset that the user has selected or that is available depending on the location of the mobile client. In at least these ways, the AR system described herein optimizes avatar customization and manipulation for mobile client devices.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for gesture tracking in an augmented reality environment executed on a mobile client through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer readable storage medium comprising stored instructions, the instructions when executed by a processor cause the processor to:
receive a modification to a base feature of a three-dimensional (3D) avatar, the 3D avatar generated for display through a mobile client device, the 3D avatar generated using base features and part features, the part features provided for display over at least one of the base features, the base features unaffected by changes to the part features, and at least one of the part features affected by changes to the base features;
identify a part feature displayed over the base feature;
determine a modification to the part feature using the modification to the base feature;
provide for display through the mobile client device an animation depicting a first view of the 3D avatar, the first view including the modified base feature and the modified part feature at a first angle;
receive, during display of the animation, a request to display a second view of the 3D avatar, the second view including the modified base feature and the modified part feature at a second angle;
determine the second angle from which to display the modified base feature and the modified part feature in the animation; and
provide for display through the mobile client device the animation depicting the second view of the 3D avatar.

2. The non-transitory computer readable storage medium of claim 1, wherein the base feature comprises physical features of a human body.

3. The non-transitory computer readable storage medium of claim 1, wherein the instructions to determine the modification to the part feature using the modification to the base feature further comprise instructions that when executed by the processor cause the processor to:
determine, responsive to the modification to the base feature including a change in a size of the base feature, a proportionate change in a size of the part feature.

4. The non-transitory computer readable storage medium of claim 1, wherein the instructions further comprise instructions that when executed by the processor cause the processor to:
provide for display through the mobile client device a slider for selecting an appearance parameter from a continuous scale of parameters for the base feature.

5. The non-transitory computer readable storage medium of claim 4, wherein the continuous scale of parameters corresponds to a representation of a weight of a body of the 3D avatar.

6. The non-transitory computer readable storage medium of claim 1, wherein the 3D avatar is an augmented reality (AR) avatar.

7. The non-transitory computer readable storage medium of claim 1, wherein the instructions further comprise instructions that when executed by the processor cause the processor to:
modify, responsive to determining that the AR avatar is provided for display on a flat real-world surface, user permissions to enable a user to request a change in a presently displayed view of the AR avatar.

8. The non-transitory computer readable storage medium of claim 1, wherein the first animation is provided with at least one of a continuous panning camera view or a zooming camera view, the request to display the second view detected at the mobile client device upon user interaction with the continuous panning camera view or the zooming camera view.

9. The non-transitory computer readable storage medium of claim 1, wherein the instructions further comprise instructions that when executed by the processor cause the processor to:
receive a template for a video clip, the template including a default 3D avatar;
replace the default 3D avatar with the 3D avatar, the 3D avatar including the modified base feature and modified part feature; and
provide for display through the mobile client device the video clip including the 3D avatar.

10. The non-transitory computer readable storage medium of claim 1, wherein the part features comprise digital representations of clothing and accessories for the 3D avatar.

11. The non-transitory computer readable storage medium of claim 1, wherein the part features are a portion of an entirety of available part features, a given available part feature provided to the mobile client device for download upon user request.

12. The non-transitory computer readable storage medium of claim 11, wherein the instructions further comprise instructions that when executed by the processor cause the processor to:
determine a location of the mobile client device; and
determine the available part features using the location of the mobile client device.

13. A computer system comprising:
a customization module configured to:
receive a modification to a base feature of a three-dimensional (3D) avatar, the 3D avatar generated for display through a mobile client device, the 3D avatar generated using base features and part features, the part features provided for display over at least one of the base features, the base features unaffected by changes to the part features, and at least one of the part features affected by changes to the base features;
identify a part feature displayed over the base feature; and
determine a modification to the part feature using the modification to the base feature; and
a rendering module coupled to the customization module configured to:
provide for display through the mobile client device an animation depicting a first view of the 3D avatar, the first view including the modified base feature and the modified part feature at a first angle;
receive, during display of the animation, a request to display a second view of the 3D avatar, the second view including the modified base feature and the modified part feature at a second angle;
determine the second angle from which to display the modified base feature and the modified part feature in the animation; and
provide for display through the mobile client device the animation depicting the second view of the 3D avatar.

14. The computer system of claim 13, wherein the rendering module is further configured to:
provide for display through the mobile client device a slider for selecting an appearance parameter from a continuous scale of parameters for the base feature, wherein the continuous scale of parameters represents a weight of a body of the 3D avatar.

15. The computer system of claim 13, wherein the 3D avatar is an augmented reality (AR) avatar.

16. The computer system of claim 13, wherein the rendering module is further configured to:
modify, responsive to determining that the AR avatar is provided for display on a flat real-world surface, user permissions to enable a user to request a change in a presently displayed view of the AR avatar.

17. A computer-implemented method comprising:
receiving a modification to a base feature of a three-dimensional (3D) avatar, the 3D avatar generated for display through a mobile client device, the 3D avatar generated using base features and part features, the part features provided for display over at least one of the base features, the base features unaffected by changes to the part features, and at least one of the part features affected by changes to the base features;
identifying a part feature displayed over the base feature;
determining a modification to the part feature using the modification to the base feature;
providing for display through the mobile client device an animation depicting a first view of the 3D avatar, the first view including the modified base feature and the modified part feature at a first angle;
receiving, during display of the animation, a request to display a second view of the 3D avatar, the second view including the modified base feature and the modified part feature at a second angle;
modifying the animation, the modified animation including views of the modified base feature and the modified part feature at the second angle; and
providing for display through the mobile client device the modified animation depicting the second view of the 3D avatar.

18. The computer-implemented method of claim 17, further comprising:
providing for display through the mobile client device a slider for selecting an appearance parameter from a continuous scale of parameters for the base feature, wherein the continuous scale of parameters represents a weight of a body of the 3D avatar.

19. The computer-implemented method of claim 17, wherein the 3D avatar is an augmented reality (AR) avatar.

20. The computer-implemented method of claim 17, further comprising:
modifying, responsive to determining that the AR avatar is provided for display on a flat real-world surface, user permissions to enable a user to request a change in a presently displayed view of the AR avatar.
